(19) United States
(12) Patent Application Publication
(10) Pub. No.: US 2005/0069195 A1
(43) Pub. Date: Mar. 31, 2005

(54) Apparatus and method for establishing correspondence between images

(75) Inventors: Shinobu Uezono, Saitama (JP); Masami Shirai, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/951,656

(22) Filed: Sep. 29, 2004

(30) Foreign Application Priority Data
Sep. 29, 2003 (JP) P2003-337266

(51) Int. Cl. G06K 9/00

(52) U.S. Cl. 382/154

(57) ABSTRACT

An apparatus for establishing correspondence between a first and a second image which includes the same object is provided. The apparatus comprises a point designator, a first image extractor, and a corresponding point searcher. The point designator is used to designate a point on the first image. The first image extractor extracts a predetermined area of an image surrounding the designated point as a first extracted image. The corresponding point searcher searches a point on the second image, which corresponds to the designated point on the first image by image matching between the first extracted image and the second image. Further, the resolutions of the first and second images are different from each other.

### BACKGROUND OF THE INVENTION

1. Field of the Invention

The present invention relates to an apparatus and a method that searches an image to find a point corresponding to a point in another image.

2. Description of the Related Art

Due to the recent wide spread use of digital cameras, digital images are also brought into use in the field of surveying systems. For example, the digital images are used as stereo images in Japanese patent publication No. 3192875. Further, the digital images may be used for recording situations or conditions at a surveying scene. For example, in Japanese unexamined patent application No. 11-337336, a surveying apparatus provided with a high-resolution digital camera is disclosed.

In the field of surveying, the operations for designating and specifying a certain position (e.g. a point corresponding to a station) on an image is generally required. For example, in the analytical photogrammetry using stereo images, it is necessary to designate positions of a station in each of the stereo images for obtaining the tree-dimensional coordinates of the station. Conventionally, this is carried out by a user. Namely, the user designates the points, which correspond to the station, in each of the digital stereo images displayed on a monitor.

Further, after surveying the stations with a surveying apparatus, such as a total station, a theodolite, and the like, a report is normally made. In this type of report, the position of the station is indicated on images to distinctly point out where the measurement was carried out.

### SUMMARY OF THE INVENTION

However, for example, when the resolution of an imaging device(s) used in the stereo image capturing is not high enough, the designation of the corresponding points in the respective right and left images cannot be carried out precisely. Further, the precise indication of the position of a station on surveying images is also cumbersome and difficult.

According to the present invention, an apparatus for establishing correspondence between a first and a second image which includes the same object image is provided. The apparatus comprises a point designator, a first image extractor, and a corresponding point searcher.

The point designator is used to designate a point on the first image. The first image extractor extracts a predetermined area of an image surrounding the designated point as a first extracted image. The corresponding point searcher searches a point on the second image, which corresponds to the designated point on the first image by image matching between the first extracted image and the second image. Further, the resolutions of the first and second images are different from each other.

Further, according to the present invention, a computer program product for establishing correspondence between a first and a second image which includes the same object image is provided. The computer program product comprises a point designating process, a first image extracting process, and a corresponding point searching process.

The point designating process designates a point on the first image as a designated point. The first image extracting process extracts a predetermined area of an image surrounding the designated point as a first extracted image. The corresponding point searching process searches a point on the second image, which corresponds to the designated point on the first image by image matching between the first extracted image and the second image. The resolutions of the first and second images are different from each other.

Further, according to the present invention, a method for establishing correspondence between a first and a second image which includes the same object image is provided. The method comprises steps of designating a point on said first image as a designated point, extracting a predetermined area of the image surrounding the designated point as a first extracted image, and searching a point on the second image, which corresponds to the designated point on the first image by image matching between the first extracted image and the second image. Further, the resolutions of the first and second images are different from each other.

Further, according to the present invention, the surveying system comprises a stereo image capturer, a telephoto image capturer, a telephoto image capturer controller, a low-resolution image extractor, and a corresponding point searcher.

The stereo image capturer captures a stereo image having a relatively wide angle of view and a low resolution. The telephoto image capturer captures a telephoto image having a relatively narrow angle of view and a high resolution. The telephoto image capturer controller captures a plurality of telephoto images that cover an area imaged by the stereo image by rotating the telephoto image capturer. The low-resolution image extractor extracts a low-resolution extracted image from the stereo image. The low-resolution extracted image comprises a predetermined area surrounding a designated point which is designated on the telephoto image. The corresponding point searcher searches a point on the stereo image, which corresponds to the designated point on the telephoto image by image matching between the low-resolution extracted image and the telephoto image, by sub pixel level accuracy.

Further, according to the present invention, a surveying system is provided that comprises a surveying apparatus, a first image capturer, a second image capturer, an image extractor, and a corresponding point searcher.

The surveying apparatus obtains an angle for and distance of a measurement point which is sighted. The first image capturer images an image of the measurement point. The position of the first image capturer with respect to the surveying apparatus is known. The second image capturer images an image of the measurement point at a resolution which is different from the image captured by the first image capturer from a position separate from the surveying apparatus. The image extractor extracts an extracted image from the image captured by the first image capturer, and the extracted image comprises a predetermined area surrounding the measurement point. The corresponding point searcher searches for a point corresponding to the measurement point on the image captured by the second image capturer, by image matching between the extracted image and the image captured by the second image capturer.

### BRIEF DESCRIPTION OF THE DRAWINGS

The objects and advantages of the present invention will be better understood from the following description, with reference to the accompanying drawings in which:

FIGS. 1A and 1B are perspective views of a stereo-image capturing apparatus used in an analytical photogrammetry system of a first embodiment of the present invention;

FIG. 2 is a block diagram showing a general electrical construction of the stereo-image capturing apparatus of the first embodiment;

FIG. 3 is a cross sectional view of the camera rotator;

FIG. 4 is a flowchart showing processes carried out in the microcomputer of the stereo-image capturing apparatus;

FIG. 5 schematically illustrates the relationship between the rotation angle of the camera rotator and the horizontal view angles of the stereo camera and the telephoto camera;

FIG. 6 schematically illustrates an image corresponding to a right (left) image obtained by the stereo camera, which is obtained by connecting four telephoto images;

FIG. 7 schematically illustrates the four separate telephoto images that compose the image depicted in FIG. 6;

FIG. 8 is a flowchart of a rotational operation for the camera rotators;

FIG. 9 is a flowchart of an image-matching operation which is carried out by a computer;

FIG. 10 schematically illustrates the relationship between a low-resolution extracted image and a high-resolution extracted image;

FIG. 11 is a flowchart of a parameter calculating operation which is carried out in Step S302;

FIGS. 12A and 12B are perspective views of a stereo-image capturing apparatus used in an analytical photogrammetry system of the alternative embodiment;

FIG. 13 schematically illustrates the relationship among a rotation angle of the camera rotator, the view angle of the stereo camera and the telephoto camera;

FIG. 14 schematically illustrates constructions of the surveying system of the second embodiment;

FIG. 15 is a block diagram showing an electrical construction of the surveying system;

FIG. 16 is a flowchart of the surveying process carried out by the surveying system of the second embodiment; and

FIG. 17 depicts examples of the measurement point images captured by the external digital camera and the built-in camera of the surveying apparatus.

### DESCRIPTION OF THE PREFERRED EMBODIMENTS

The present invention is described below with reference to the embodiments shown in the drawings.

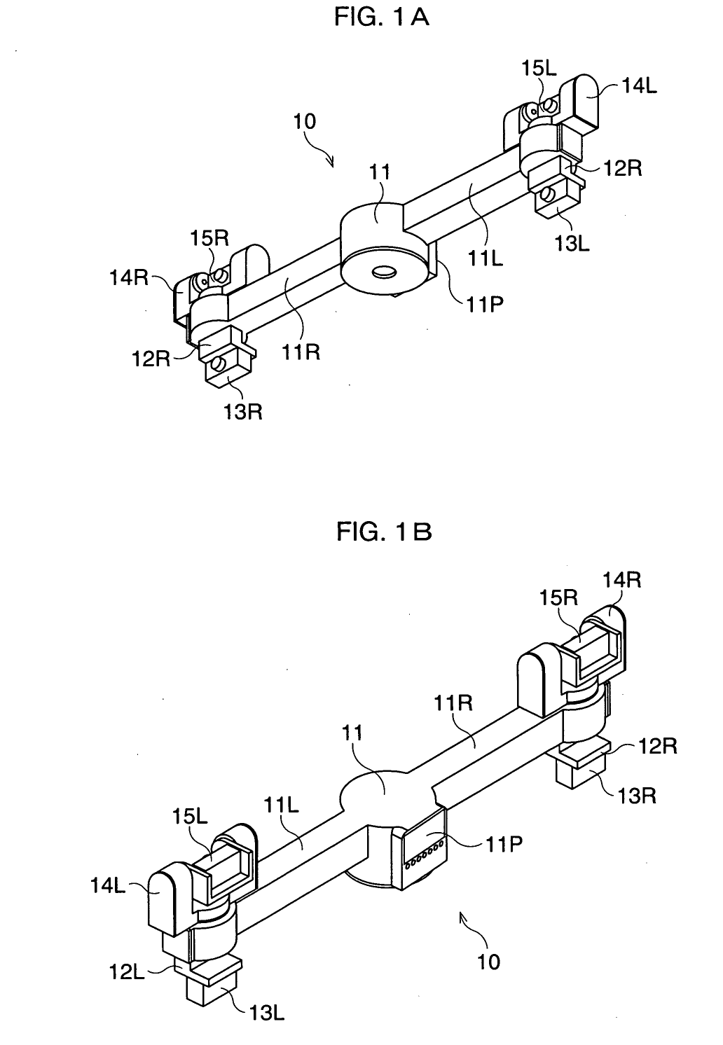

FIGS. 1A and 1B are perspective views of a stereo-image capturing apparatus used in an analytical photogrammetry system of a first embodiment of the present invention. Namely, FIG. 1A is the front perspective view from a lower position, and FIG. 1B is rear perspective view from an upper position.

The stereo-image capturing apparatus 10 of the first embodiment has a central controller 11 and beams 11L and 11R that extend out from both the right and left sides of the central controller 11. Beneath each end portion of the right and left beams 11R and 11L, camera mounting sections 12R and 12L are respectively provided, where a right stereo camera 13R and a left stereo camera 13L are mounted. Further, on top of both end portions of the right and left beams 11R and 11L, camera rotators 14R and 14L are provided, where telephoto cameras 15R and 15L are mounted.

Further, digital cameras are used for the stereo cameras 13R, 13L and the telephoto cameras 15R, 15L. The right and left stereo cameras 13R and 13L are for photogrammetry, so that they are precisely positioned and fixed to each of the camera mounting sections 12R and 12L. Therefore, the positional relationship between the right and left stereo cameras 13R and 13L is preset with high accuracy. Further, the inner orientation parameters for the right and left stereo cameras 13R and 13L are also accurately calibrated.

On the other hand, the telephoto cameras 15R and 15L are cameras to capture telephotography, so that their focal length is relatively long and their camera angle of view is relatively narrow, with respect to the right and left stereo cameras 13R and 13L. However, the alignment and the inner orientation parameters of the telephoto cameras 15R and 15L are not required to be so precise as those for the stereo cameras 13R and 13L. Note that, in the first embodiment, all the stereo cameras 13R and 13L, and the telephoto cameras 15R and 15L are provided with the imaging devices (e.g. CCDs) having the same number of pixels. Therefore, the telephoto cameras 15R and 15L, having a relatively narrow angle of view, can obtain an object image (a high resolution image) which is more precise than an object image obtained by the stereo cameras 13R and 13L having a wide angle of view.

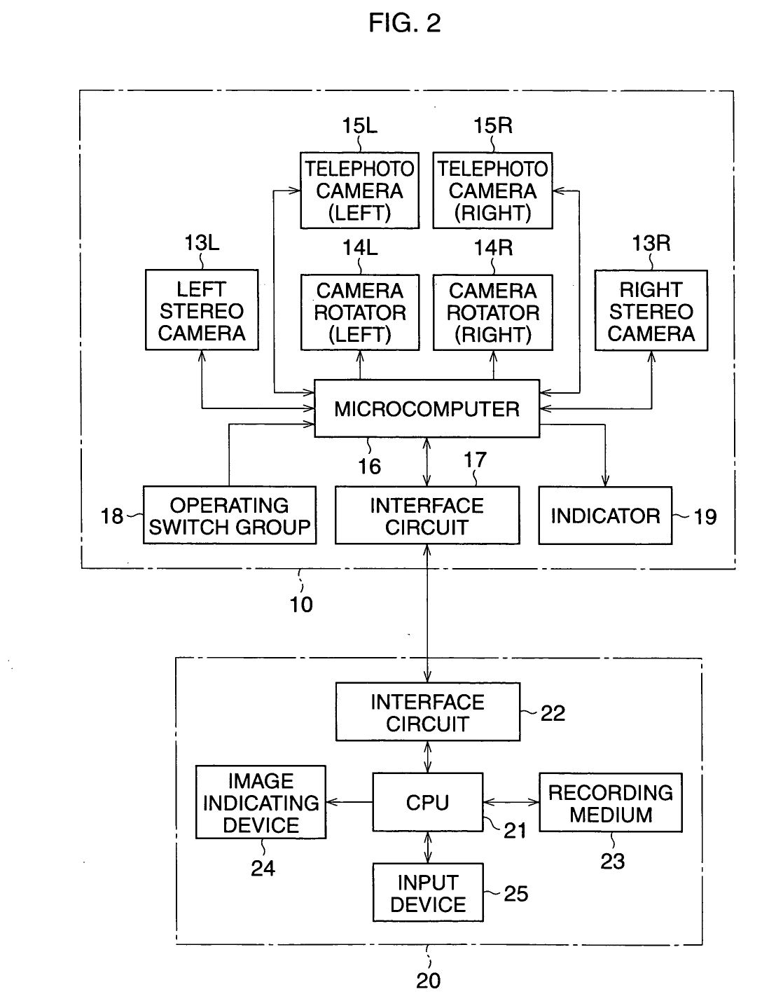

Note that, the stereo-image capturing apparatus 10 is fixed on a supporting member, such as a tripod, at the bottom of the central controller 11. Further, inside the central controller 11, the microcomputer 16 (see FIG. 2) is mounted and the stereo-image capturing apparatus 10 is integrally controlled by the microcomputer 16. Further, the microcomputer 16 controls the stereo-image capturing apparatus 10 in accordance with the switch operations of a control panel 11P provided on the backside of the central controller 11.

FIG. 2 is a block diagram showing a general electrical construction of the stereo-image capturing apparatus 10 of the first embodiment.

As described above, the stereo-image capturing apparatus 10 comprises the right and left stereo cameras 13R and 13L, the right and left camera rotators 14R and 14L, and the right and left telephoto cameras 15R and 15L. These components are all connected and controlled by the microcomputer 16, which is mounted in the central controller 11. Namely, the release operations of the stereo cameras 13R and 13L and the telephoto cameras 15R and 15L are carried out based on control signals from the microcomputer 16 and images captured by each of the cameras are fed to the microcomputer 16.

Further, an interface circuit 17 is connected to the microcomputer 16, so that it is able to connect the microcomputer 16 to an external computer 20 (e.g. a notebook sized personal computer) via the interface circuit 17. Namely, the image data fed from each camera to the microcomputer 16 can be transmitted to the computer 20 through a certain communication medium, such as an interface cable. On the other hand, control signals can be transmitted from the computer 20 to the microcomputer 16. Further, an operating switch group 18 of the control panel 11P and an indicator 19 are also connected to the microcomputer 16.

The computer 20 generally comprises a CPU 21, an interface circuit 22, a recording medium 23, a display (image-indicating device) 24, and an input device 25. The image data transmitted from the microcomputer 16 of the stereo-image capturing apparatus 10 are stored in the recording medium 23 via the interface circuit 22. Further, image data stored in the recording medium 23 can be indicated on the display 24 when it is required. Furthermore, the computer 20 is operated through the input device 25, including a pointing device, such as a mouse and the like, and a keyboard.

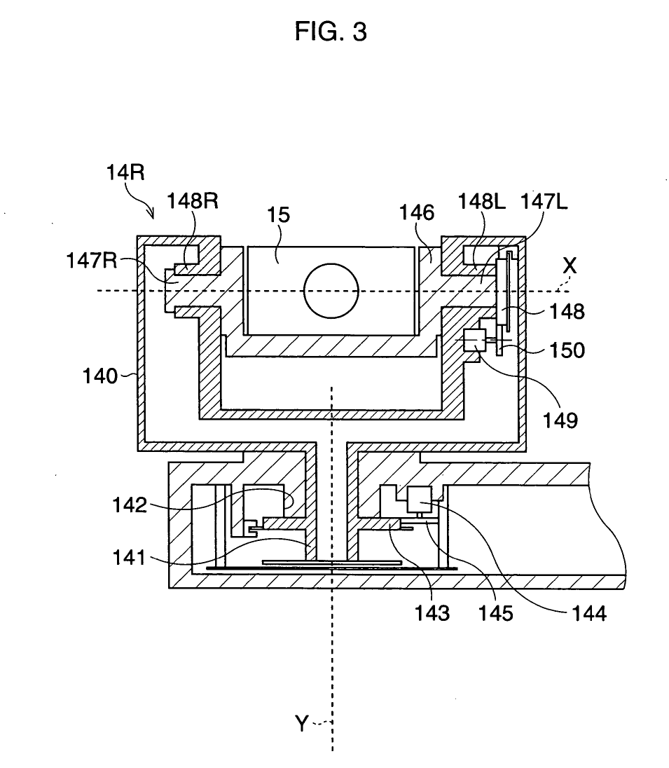

Next, with reference to FIG. 3, the configuration of the camera rotators 14R and 14L will be explained. The camera rotators 14R and 14L have a mechanism for traversing the telephoto cameras 15R and 15L, vertically and horizontally, and the rotational movement is controlled by drive signals from the microcomputer 16. Note that, the left camera rotator 14L has the same structure as that of the right camera rotator 14R, so that only the structure relating to the right camera rotator 14R is explained and the structure of the left camera rotator 14L is omitted.

FIG. 3 is a cross sectional view of the camera rotator 14R. The configuration of the body 140 of the camera rotator 14R is U-shaped, so that a vertical rotating-shaft 141 is provided at the center of the base portion of the body 140. On the other hand, a boss bearing 142 is formed on the top of the right end of the right beam 11R for receiving the vertical rotating-shaft 141 of the camera rotator 14R. Inside the end portion of the right beam 11R, a gear 143 is attached to the vertical rotating-shaft 141. Further, the gear 143 engages with a pinion gear 145 which is connected to a drive motor 144, such as a stepping motor and the like. Namely, the drive motor 144 is rotated based on control signals from the central controller 11, so that the rotation of the camera rotator 14R about the vertical axis Y is carried out.

A platform 146 for mounting the right telephoto camera 15R is positioned at the inside area of the U-shaped body 140 of the camera rotator. The platform 146 is also configured as a U-shape so that the telephoto camera 15R is mounted and fastened at the inside portion of the U-shaped platform 146 by a fastener, such as a screw or the like. On both outer sidewalls of the platform 146, horizontal rotating-shafts 147R and 147L are provided. Each of the horizontal rotating-shafts 147R and 147L is journaled into bosses 148R and 148L formed on the inner sidewalls, which are facing each other, of the camera rotator 14R. Further, a gear 148 is provided at the end of the horizontal rotating-shafts 147L, so that a pinion gear 150 attached to a drive motor 149 (e.g. a stepping motor) is engaged with the gear 148. Namely, the drive motor 149 is rotated about the horizontal axis X based on control signals from the microcomputer 16, thereby rotating the platform 146 about the horizontal axis X.

According to the structure described above, the telephoto camera 15R (15L), affixed to the platform 146 of the camera rotator 14R (14L), can be oriented toward any direction due to the drive signals from the microcomputer 16.

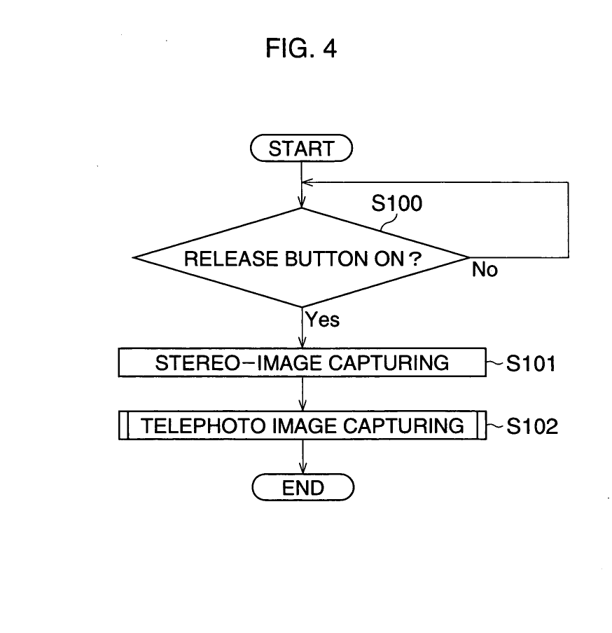

Next, with reference to FIG. 4, procedures generally carried out throughout the photographing or imaging operations of the photogrammetry system of the first embodiment are explained. Note that, FIG. 4 is a flowchart showing the processes carried out in the microcomputer 16 of the stereo-image capturing apparatus 10.

In Step S100, whether the release button provided in the operating switch group 18 of the control panel 11P has been pressed is determined. When the release button is pressed, both the right and left stereo cameras 13R and 13L simultaneously capture a pair of images as a stereo image in Step S101. Further, when the image capturing operation of the stereo cameras 13R and 13L ends, the camera rotators 14R and 14L are being controlled, in Step S102, and then the image capturing operation of the telephoto cameras 15R and 15L begins. The directions of the telephoto cameras 15R and 15L are controlled by the camera rotators 14R and 14L to image the area corresponding to the stereo image. Note that the image capturing operation for the photogrammetry ends when the telephotographing in Step S102 is completed.

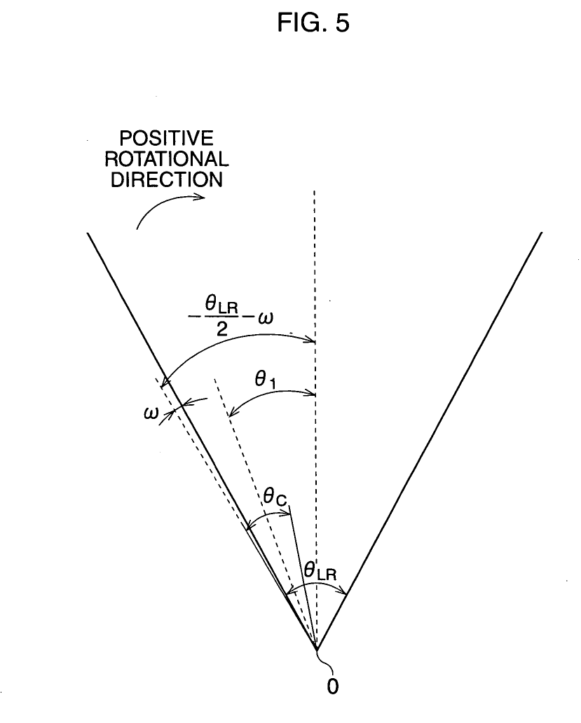

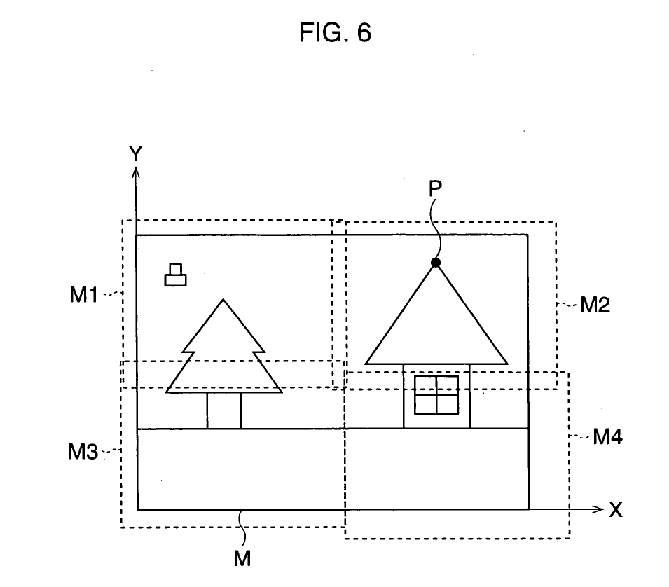

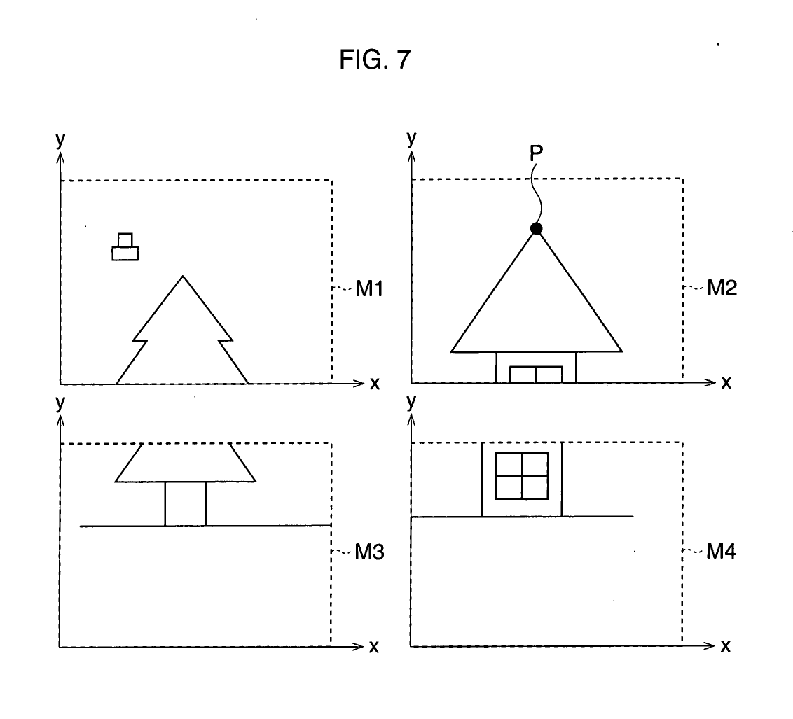

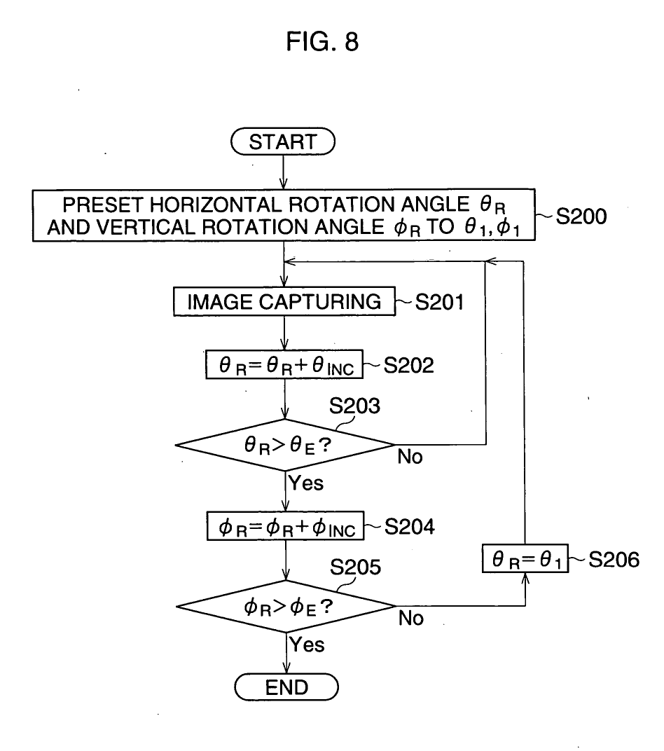

With reference to FIGS. 5 to 8, the details of the telephotographing operation of Step S102 will be explained. FIG. 5 schematically illustrates the relationship between the rotation angle of the camera rotator 14R (14L) and the horizontal view angles of the stereo camera and the telephoto camera. FIG. 6 schematically illustrates an image corresponding to a right (left) image obtained by the stereo camera 13R (13L), which is obtained by connecting four telephoto images that are separately illustrated in FIG. 7. Further, FIG. 8 is a flowchart of a rotational operation for the camera rotators 14R and 14L.

In FIG. 5, “θ_{LR}” corresponds to the horizontal view angle of the stereo camera 13R (13L) and “θ_{C}” corresponds to the horizontal view angle of the telephoto camera 15R (15L). The origin “O” corresponds to the center of the projection or the viewpoint of the stereo camera 13R (13L) and the telephoto camera 15R (15L). Note that, in the present explanation, the stereo camera 13R (13L) and the telephoto camera 15R (15L) are assumed to be positioned at the same point, for convenience, so that the explanation is made from a position as if the center of the projections of each of the stereo cameras 13R (13L) and the telephoto cameras 15R (15L) coincide with each other.

As it is apparent from FIG. 5, the telephoto cameras 15R and 15L are able to rotate about the vertical axis Y by using the camera rotators 14R and 14L, so that the area within the horizontal view angles θ_{LR} that is imaged by the stereo cameras 13R and 13L can be thoroughly imaged along the horizontal direction. Thereby, images with the horizontal view angle θ_{LR}, which are captured by the stereo cameras 13R and 13L, can be reproduced along the horizontal direction by combining a plurality of images with the horizontal view angle θ_{C}, which are captured by the telephoto cameras 15R and 15L.

Further, the telephoto cameras 15R and 15L are able to rotate about the horizontal axis X by using the camera rotators 14R and 14L. Thereby, images with the vertical view angle φ_{LR}, which are captured by the stereo cameras 13R and 13L, can be reproduced along the vertical direction by composing a plurality of images with the vertical view angle φ_{C}, which are captured by the telephoto cameras 15R and 15L, thoroughly along the vertical direction, within the vertical view angle φ_{LR}. Therefore, each of images the obtained by the stereo cameras 13R and 13L can be reproduced as a composite image, which is composed of the plurality of images captured by the telephoto cameras 15R and 15L while horizontally and vertically rotating the telephoto cameras 15R and 15L.

Since the telephoto cameras 15R and 15L use imaging devices having the same number of pixels as the imaging devices for the stereo cameras 13R and 13L, the resolution of an image obtained from the telephoto images captured by the telephoto cameras 15R and 15L, and of which the area corresponds to the area imaged by the stereo cameras 13R and 13L, is more precise than an image captured by the stereo cameras 13R and 13L. As shown in FIG. 6, for example, one of the images captured by the stereo cameras 13R and 13L is reproduced by four telephoto images M1 to M4 indicated in FIG. 6. For example, each of the telephoto images M1 to M4 is captured including an overlapping area which overlaps with neighboring images so that occurrence of unimaged area is prevented. In the present embodiment, each of the images captured by the stereo cameras 13R and 13L is reproduced by four telephoto images M1 to M4, therefore, the composite stereo images will be reproduced with four times the number of pixels than the images captured by the stereo cameras 13R and 13L, themselves.

In Step S200, the horizontal rotation angle θ_{R} and the vertical rotation angle φ_{R} of the telephoto cameras 15R and 15L are initialized to the initial angles θ₁ and φ₁ which are described in the following equations.
θ₁=−θ_{LR}/2+θ_{C}/2−ω
φ₁=−φ_{LR}/2+φ_{C}/2−ω
Note that, the positive direction of the horizontal rotation angle is determined as clockwise in FIG. 5, and the positive direction of the vertical rotation angle is determined as upward rotation. The angle ω is an overlapping angle which is set in advance in order to prevent the remaining area, and is preset to a predetermined value. Namely, as shown in FIG. 5, the initial value θ₁ of the horizontal rotation angle θ_{R} is preset to an angle where the telephoto cameras 15R and 15L are further rotated in the counter clockwise direction by the overlapping angle ω, from where the left boundary line of the horizontal view angle θ_{C}, of the telephoto cameras 15R and 15L, coincides with the left boundary line of the horizontal view angle θ_{LR} of the stereo cameras 13R and 13L. Further, although it is not shown in the drawings, the initial value φ₁ of the vertical rotation angle φ_{R} is preset to an angle where the telephoto cameras 15R and 15L are further rotated in the counter clockwise direction by the overlap angle ω from where the lower boundary line of the vertical view angle φ_{C} of the telephoto cameras 15R and 15L coincides with the lower boundary line of the vertical view angle φ_{LR} of the stereo cameras 13R and 13L.

In Step S201, telephoto images where the telephoto cameras 15R and 15L are oriented are captured. In Step S202, an angle θ_{INC} is added to the current horizontal rotation angle θ_{R} of the telephoto camera 15R and 15L, so that the angle θ_{R} is altered to the new value θ_{R}+θ_{INC}. Note that, the angle θ_{INC} represents a step of the rotation angle about the vertical axis Y, and for example, is defined by the following formula.
θ_{INC}=θ_{C}−ω
Namely, the rotation step angle θ_{INC} about the vertical axis Y is given as the remainder of the subtraction between the horizontal view angle θ_{C} and the overlap angle ω. Thereby, each of the images captured by the telephoto camera 15R (15L) will be overlapped by the overlap angle ω along the horizontal direction.

In Step S203, whether the current horizontal rotation angle θ_{R} is greater than the horizontal maximum angle θ_{E} is determined. The horizontal maximum angle θ_{E} is an angle for determining whether all of the area within the horizontal view angle θ_{LR} of the stereo camera 13R and 13R has been captured along the horizontal direction by the telephoto cameras 15R and 15L, and it is determined by the following formula.
θ_{E}=θ_{LR}/2+θ_{C}/2
Namely, the horizontal maximum angle θ_{E} corresponds to an angle where the left boundary line of the horizontal view angle θ_{C} of the telephoto cameras 15R and 15L coincides with the right boundary line of the horizontal view angle θ_{LR} of the stereo cameras 13R and 13L.

When it is determined, in Step S203, that the horizontal rotation angle θ_{R} is not greater than the horizontal maximum angle θ_{E}, the telephoto cameras 15R and 15L are rotated about the vertical axis Y to the new horizontal rotation angle θ_{R}, and then the process returns to Step S201. Namely, until the horizontal rotation angle θ_{R} exceeds the horizontal maximum angle θ_{E}, the telephoto cameras 15R and 15L are rotated in the clockwise direction about the vertical axis Y by the rotation step angle θ_{INC}, and telephoto images are taken in order.

On the other hand, when it is determined, in Step S203, that the horizontal rotation angle θ_{R} is greater than the horizontal maximum angle θ_{R}, the current vertical rotation angle φ_{R} is incremented by φ_{INC}, so that the vertical rotation angle φ_{R} is altered to the new value φ_{R}+φ_{INC}. Note that, the angle φ_{INC} represents a step of the rotation angle about the horizontal axis X, and for example, is defined by the following formula.
φ_{INC}=φ_{C}−ω
Namely, the rotation step angle φ_{INC} about the horizontal axis X is given as the remainder of the subtraction between the vertical view angle φ_{C} and the overlap angle ω. Thereby, each of the images captured by the telephoto camera 15R (15L) will be overlapped by the overlap angle ω along the vertical direction.

Further, in Step S205, whether the current vertical rotation angle φ_{R} is greater than the vertical maximum angle φ_{E} is determined. The vertical maximum angle φ_{E} is an angle for determining whether all of the area within the vertical view angle φ_{LR} of the stereo camera 13R and 13R has been captured along the vertical direction by the telephoto cameras 15R and 15L, and it is determined by the following formula.
φ_{E}=φ_{LR}/2+φ_{C}/2
Namely, the vertical maximum angle φ_{E} corresponds to an angle where the lower boundary line of the vertical view angle φ_{C} of the telephoto cameras 15R and 15L coincides with the upper boundary line of the vertical view angle φ_{LR} of the stereo cameras 13R and 13L.

When it is determined, in Step S205, that the vertical rotation angle φ_{R} is not greater than the vertical maximum angle φ_{E}, in Step S206, the horizontal rotation angle θ_{R} is again reset to the initial value θ₁, and the telephoto cameras 15R and 15L are rotated about the horizontal and vertical axes X and Y by the camera rotator 14R and 14L due to the new horizontal rotation angle θ_{R} and the new vertical rotation angle φ_{R}. Further, the process returns to Step S201 and the above-described processes are repeated. Namely, until the vertical rotation angle φ_{R} exceeds the vertical maximum angle φ_{E}, the telephoto cameras 15R and 15L are rotated in the upward direction about the horizontal axis X by the rotation step angle φ_{INC}, and telephoto images are taken in order.

On the other hand, when it is determined, in Step S205, that the vertical rotation angle φ_{R} is greater than the vertical maximum angle φ_{E}, this telephotographing operation ends, since all of the area corresponding to the image captured by the stereo cameras 13R and 13L should be imaged by the telephoto cameras 15R and 15L without any part remaining.

Note that, in the present embodiment, all the telephotographing operation is carried out by the microcomputer 16 of the stereo-image capturing apparatus 10, however, the external computer 20 can share some of the processes. For example, the horizontal and vertical rotation angles can be calculated by the computer 20, so that the microcomputer 16 merely controls the camera rotator 14R and 14L as to the rotation angle data fed from the external computer 20.

Next, with reference to FIGS. 5, 9, and 10, an image-matching operation (e.g. a template matching) of the first embodiment, which is carried out between a high-resolution image and a low-resolution image, will be explained. The image-matching operation is generally carried out by using an external computer 20, after image data from the stereo-image capturing apparatus 10 is transmitted to the external computer 20.

When the operation is started, only one of the images (right and left images), which was captured by the stereo cameras 13R and 13L, is indicated on the display 24 of the computer 20. In the following description, the left image is presumed to be indicated on the display 24 for convenience of explanation, however, it could also be replaced by the right image.

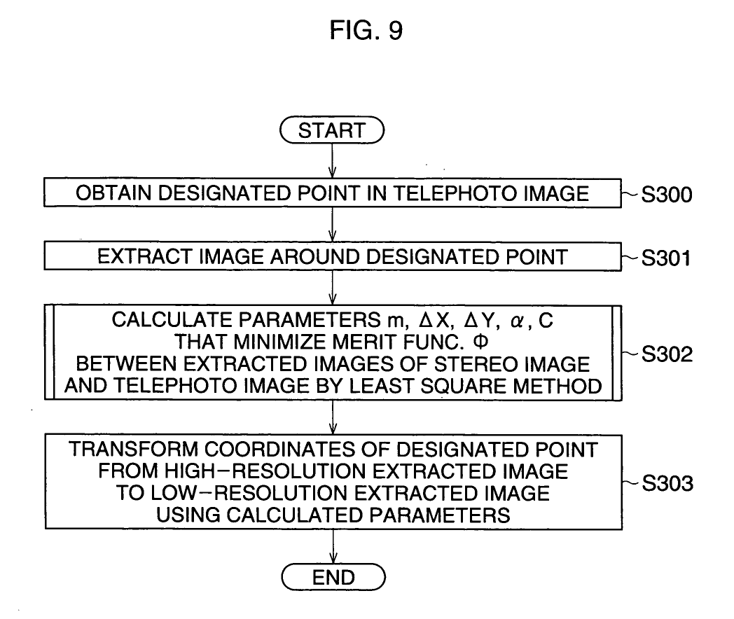

From the left image, which is displayed on the display 24, a measurement point (pixel) where a user intends to measure (e.g. a point P in FIG. 6) is designated by using a pointing device of the input device 25, such as a mouse. Thereby, the computer 20 obtains the position of the designated measurement point (pixel) and selects a telephoto image that includes an image corresponding to the designated measurement point (e.g. selects the telephoto image M2 from the telephoto images M1-M4, which include the point P). Further, the selected telephoto image is displayed on the display 24. Namely, a magnified image (telephoto image), such that a precise or fine image including the designated measurement point, is displayed on the display 24. Further, the image-matching operation of the flowchart of FIG. 9 is carried out by the computer 20. Note that, a telephoto image including the designated measurement point can be easily identified from the other images when the measurement point (pixel) is designated on the left image of the stereo camera 13L, since the rotation step angle of the telephoto camera 15L (15R) or the orientation of the telephoto camera, the view angle of the stereo camera 13L (13R), and the view angle of the telephoto camera 15L (15R) are known, and the center of projections for each of the stereo camera 13L (13R) and the telephoto camera 15L (15R) can be regarded to be the same position.

In Step S300, the user again designates the above measurement point or pixel (e.g. the point P in FIG. 7) on the telephoto image (e.g. telephoto image M2) indicated on the display 24. Namely, this allows the user to designate the measurement point (pixel) accurately, once again, on the magnified precise telephoto image. Further, the position of the designated measurement point on the telephoto image, the point where the mouse is clicked, is obtained at this time.

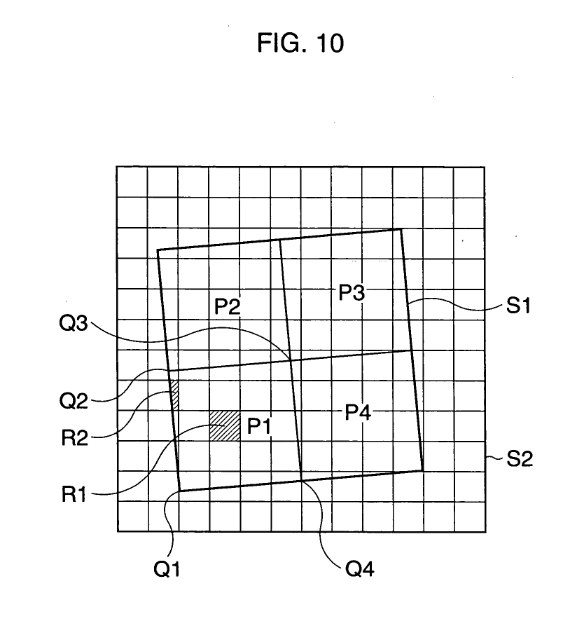

In Step S301, an image with a predetermined size and a predetermined shape (an extracted image) is extracted from each of the telephoto images and the left image. For example, the extracted image is an image having a rectangular shape with the center at the measurement point. Further, as shown in FIG. 10, the size of the low-resolution extracted image S1, which is extracted from the left image, is preset to the size smaller than the high-resolution extracted image S2, which is extracted from the telephoto image, so that the low-resolution extracted image S1 can be included within the high-resolution extracted image S2. Any size can be adopted for the high-resolution extracted image S2 as long as it can cover the entire low-resolution extracted image S1, so that the whole telephoto image can be adopted as the extracted image. Note that, as described above, since the rotation step angle of the telephoto camera 15L (15R) or the orientation of the telephoto camera, the view angle of the stereo camera 13L (13R), and the view angle of the telephoto camera 15L (15R) are known, and the center of projections for each of the stereo cameras 13L (13R) and the telephoto camera 15L (15R) are disposed about the same position, a position corresponding to the measurement point (pixel) designated on the telephoto image can be found easily on the left image even though it is not accurate.

In FIG. 10, a 2×2-pixel rectangular image is extracted from the left image as the low-resolution extracted image S1 and a 12×12-pixel rectangular image is extracted from the telephoto image as the high-resolution extracted image S2. Note that, in FIG. 10, the size of the low-resolution extracted image S1 and the size of the high-resolution extracted image S2 are preset to the size at which the scale of the object images in each extracted image become about the same magnitude, for the two extracted images S1 and S2, which is obtained based on the view angles of the left image and the telephoto images.

In Step S302, the accurate magnification between the images S1 and S2, XY displacement values (plane translation), a rotation angle, and a luminance compensation coefficient are calculated by using a least square method of which a merit function Φ relates to the coincidence between the low-resolution extracted image S1 of the left image and the high-resolution extracted image S2 of the telephoto image. Note that, the details of how these parameters are calculated, is discussed later.

In Step S303, the position (coordinates) corresponding to the measurement point designated on the telephoto image is accurately searched at a sub-pixel unit level from the left image by using the parameters calculated in Step S302.

As described above, according to the processes from Step S300 to Step S303, the position of the measurement point can be more precisely designated by using the high-resolution image. Further, the position of the point corresponding to the designated measurement point in the left image can be accurately obtained at the sub-pixel unit level. Furthermore, by adopting the processes in Steps S300-S303 for the right image, similar to the left image, the position of the measurement point (which corresponds to the measurement point designated in the left image) can also be precisely obtained in the right image at the sub-pixel unit level. Therefore, three-dimensional coordinates of an arbitrary measurement point can be accurately calculated by means of conventional analytical photogrammetry based on the precise positions of the measurement point in each of the right and left images (stereo image), which are represented by the sub-pixel unit level.

Next, with reference to the flowcharts of FIGS. 6, 7, 10, and 11, a parameter calculating operation carried out in Step S302 will be explained.

As shown in FIGS. 6 and 7, a position in the left (right) image, for example, is represented by using an X-Y coordinate system of which origin is at the lower left corner of the image M with a pixel as a unit for each coordinate. Similarly, a position in a telephoto image (e.g. telephoto image M2), for example, is represented by an x-y coordinate system of which the origin is at the lower left corner of each image with a pixel as a unit for each coordinate. The coordinate transformation from the x-y coordinate system to the X-Y coordinate system is then represented by following Eq. (1),

$$( \begin{matrix}X \\ Y\end{matrix} ) = m ( \begin{matrix}cos α & - sin α \\ sin α & cos α\end{matrix} ) ( \begin{matrix}x \\ y\end{matrix} ) + ( \begin{matrix}Δ X \\ Δ Y\end{matrix} ) , \qquad ( 1 )$$

where, “m” denotes the magnification, “ΔX” and “ΔY” denote the amount of XY displacement (translation), and “α” denotes the rotation angle.

In Step S400, the initial values of the parameters, such as the magnification “m”, the XY displacement ΔX and ΔY, the rotation angle “α”, and the luminance compensation coefficient “C”, are set. The initial values of the magnification “m”, the XY displacement ΔX and ΔY, and the rotation angle “α” are estimated from the rotation step angle of the telephoto camera 15L (15R), the view angle of the stereo camera 13L (13R), the view angle of the telephoto camera 15L (15R), and so on. Further, the luminance compensation coefficient “C” is a parameter to compensate for the differences between pixel values in the left image (right image) and the telephoto image. Namely, due to individual differences between the cameras, a pixel value of the left image (right image) is generally different from a value of the corresponding pixel in the telephoto image (a pixel imaging the same position of an object), even when an object is imaged captured under the same exposure conditions. In the present embodiment, the luminance compensation coefficient “C” is initially preset to “1”, such that the pixel values in the left (right) image and the telephoto image are assumed to be the same, at first. Note that, the luminance compensation coefficient “C” may be measured in advance for each combination of cameras as characteristics, by using a known a shading correction method and the like.

In Step S401, the value of the merit function Φ (detailed later) is reset to “0”, and then a pixel number “n” of the low-resolution extracted image S1, which is assigned to each of the pixels to discriminate them from each other, is reset to “1”. For example, for each of the four pixels in FIG. 10, n=1 is assigned to the pixel P1 at the lower left corner, n=2 to the pixel P2 at the upper left corner, n=3 to the pixel P3 at the upper right corner, and n=4 to the pixel P4 at the lower right corner.

In Step S403, the x-y coordinates of each of the four corner of pixels having the pixel number “n” (the coordinates which are affixed to the low-resolution extracted image) are transformed to the X-Y coordinates of the high-resolution extracted image, by substituting the current parameters m, ΔX, ΔY, α, and C into FIG. (1). For example, when n=1, the x-y coordinates (i,j) (i,j+1), (i+1,j+1), and (i+1, j) of the vertex points Q1-Q4 at each of four corners of the pixel P1 are transformed to the X-Y coordinates, where the variables “i” and “j” are integers.

In Step S404, areas Aₖ of each pixel of the high-resolution extracted image within the rectangular area defined by the four vertex points Q1-Q4 are respectively calculated in the X-Y coordinate system. Note that, here index “k” is used to identify each of the pixels in the high-resolution extracted image surrounded by the rectangular area Q1-Q4 of the low-resolution extracted image pixel Pn. For example, as shown in FIG. 10, the area of the pixel R1 which is completely included in the rectangular area Q1-Q4 is regarded as “1”, while the area of the pixel R2 which crosses over the boundary of the rectangular area Q1-Q4 is given a decimal number less than “11”, since only a part of the pixel R2 is included in the rectangular area Q1-Q4.

In Step S405, the composite luminance I_{A}⁽ⁿ⁾ for all the pixels of the high-resolution extracted image surrounded by the rectangular area corresponding the pixel Pn of the low-resolution extracted image, is calculated by the equation defined by Eq. (2).

$${I}_{A}^{( n )} = \frac{C}{{m}^{2}} {\sum }_{k}^{{N}_{k}} {A}_{k} {I}_{k} \qquad ( 2 )$$

Here, “Iₖ” represents the luminance of a pixel assigned to the pixel number “k” in the high-resolution extracted image, and “Nₖ” represents the number of the high-resolution extracted image pixels surrounded by the rectangular area of the pixel Pn.

In Step S406, the value of the merit function Φ is altered in accordance with the luminance Iₙ of the low-resolution extracted image pixel Pn and the composite luminance I_{A}⁽ⁿ⁾ which is calculated in Step S405 based on the high-resolution extracted image pixels within the pixel Pn. Namely, the value of the merit function Φ is altered by the sum of the current value of the merit function Φ and (Iₙ−I_{A}⁽ⁿ⁾).

The value of pixel number “n” is incremented by “1” in Sep S407. In Step S408, whether the pixel number “n” has reached the total pixel number N_{L} (in this embodiment N_{L}=4) of the low-resolution extracted image is determined. When it has not reached N_{L}, the process returns to Step S403 and the same processes are repeated for a newly altered pixel Pn. On the other hand, when it is determined n=N_{L}+1 in Step S408, whether the value of the merit function Φ is less than a predetermined value is determined in Step S409. Namely, whether a degree of coincidence between two images is higher than a predetermined value is determined.

When it is determined that the value of the merit function Φ is not less than the predetermined value, the variations of parameters m, ΔX, ΔY, α, and C are obtained in Step S410 by using the least square method, so that the parameters m, ΔX, ΔY, α, and C are replaced by the result that is obtained by adding the above variations to the current parameters. The process then returns to Step S401 and the same process is repeated with the latest value of the parameters m, ΔX, ΔY, α, and C. On the other hand, when it is determined, in Step S409, that the value of the merit function Φ is less than the predetermined value, this parameter calculating operation ends and the current values of the parameters m, ΔX, ΔY, α, and C are regarded as appropriate parameters for the coordinate transformation from the x-y coordinate system to the X-Y coordinate system.

Namely, in Step S303 of FIG. 9, the positions corresponding to pixels designated on the precise telephoto image as the measurement points are obtained on the both right and left images, with sub-pixel accuracy, by substituting the X-Y coordinates of the measurement point into Eq. (3), which is the inverse transformation of Eq. (1) using the parameters m, ΔX, ΔY, α, and C obtained in the above parameter calculating operation. Note that, the measurement point can also be designated on the telephoto images at a sub-pixel level by magnifying the telephoto image on the display.

$$( \begin{matrix}x \\ y\end{matrix} ) = \frac{1}{m} ( \begin{matrix}cos α & sin α \\ - sin α & cos α\end{matrix} ) ( \begin{matrix}X - Δ X \\ Y - Δ Y\end{matrix} ) \qquad ( 3 )$$

As described above, according to the photogrammetry system of the first embodiment, the position of a measurement point can be designated with high accuracy, since the measurement point can be designated on a high-resolution image. Further, the parameters for the transformation of coordinates between the high-resolution image of the telephoto camera and the low-resolution image of the stereo camera are accurately obtained by carrying out an image-matching operation around the designated measurement point, so that the positions on the low-resolution images (stereo image) that correspond to the measurement point designated on the high-resolution images (telephoto images) can be obtained accurately at sub-pixel unit level. Therefore, according to the first embodiment, the precision of the three-dimensional coordinates of the measurement point is improved without increasing the number of pixels for the stereo camera.

Further, according to the first embodiment, without increasing the number of pixels for the telephoto camera, the same effect as providing a stereo camera with a high-resolution imaging device is obtained by a simple structure, by means of controlling the view angle of the telephoto camera.

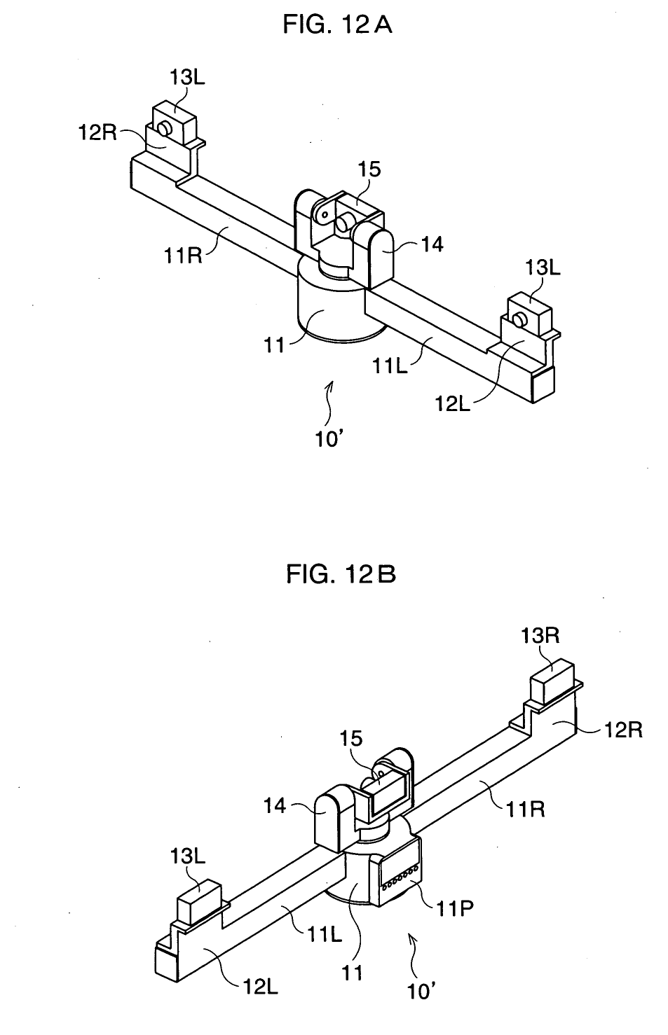

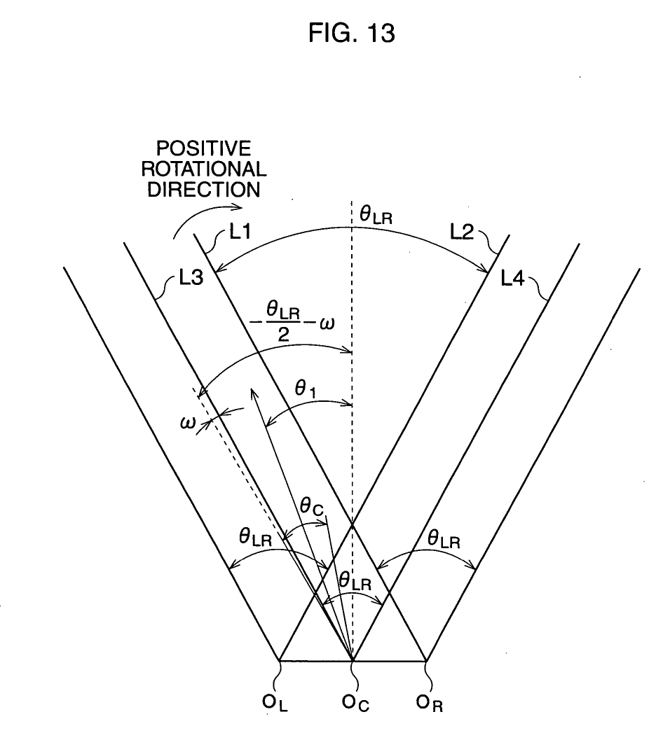

Next, with reference to FIGS. 12A, 12B, and 13, an alternative embodiment of the first embodiment will be explained. FIGS. 12A and 12B are perspective views of a stereo-image capturing apparatus 10′ used in an analytical photogrammetry system of the alternative embodiment. Namely, FIG. 12A is the front perspective view from a lower position, and FIG. 12B is rear perspective view from an upper position.

In the first embodiment, the pairs of right and left telephoto cameras and the right and left camera rotators are used. However, in the alternative embodiment, only one set of telephoto camera 15 and the camera rotator 14 is arranged at the center, as shown in FIGS. 12A and 12B. Namely, the camera rotator 14 is provided on the central controller 11 and the telephoto camera 15 on the camera rotator 14. The center of projection of the telephoto camera 15 is arranged at the midpoint of the segment between the centers of projection of the right and left stereo cameras 13R and 13L.

FIG. 13 schematically illustrates the relationship among a rotation angle of the camera rotator 14, the view angle of the stereo camera and the telephoto camera, and an overlap area between the right and left images (the area which can be measured by a stereo photogrammetry and which will be referred to as the stereo measurement area in the following).

In FIG. 13, the point O_{R} corresponds to the center of projection (or the view point) of the right stereo camera 13R, and the point O_{L} corresponds to the center of projection (or the view point) of the left stereo camera 13L. Further, the point O_{C} correspond to the center of projection (or the view point) of the telephoto camera 15. In the present alternative embodiment, the optical axes of the stereo cameras 13R and 13L are arranged to be parallel with each other, and the center of projection O_{C} of the telephoto camera 15 is positioned at the middle of the segment between the centers of projection O_{R} and O_{L}. At this time, the stereo measurement area, which is imaged by both the right and left stereo cameras 13R and 13L, is an area between the segments L1 and L2, where the segment L1 defines the left boundary of the horizontal view angle θ_{LR} of the right stereo camera 13R and the segment L2 defines the right boundary of the horizontal view angle θ_{LR} of the left stereo camera 13L. Namely, the telephoto camera 15 is rotated about the vertical axis Y by using the camera rotator 14, so that the area between the segments L3 and L4 (i.e. inside the horizontal view angle θ_{LR} of which the vertex at the center of projection O_{C}) is thoroughly imaged along the horizontal direction. Thereby, images within the stereo measurement area can be reproduced along the horizontal direction by combining a plurality of images captured by the telephoto camera 15.

Further, with regard to the vertical direction, since the centers of projection O_{L}, O_{C}, and O_{R} are substantially aligned on the same horizontal axis, and since the telephoto camera 15 can be rotated about the horizontal axis X by using the camera rotator 14, an image including the stereo measurement area can be reproduced along the vertical direction by combining a plurality of images captured by the telephoto camera 15 throughout an area within the vertical view angle φ_{LR}, with respect to the center of projection O_{C}. Therefore, each of images obtained by the stereo cameras 13R and 13L can be reproduced as a composite image, which is composed of the plurality of images captured by the telephoto camera 15 by horizontally and vertically rotating the telephoto cameras 15. Since the telephoto camera 15 uses an imaging device having the same number of pixels as the imaging devices for the stereo cameras 13R and 13L, the resolution of an image within the stereo measurement area, which is obtained from the telephoto images captured by the telephoto camera 15, becomes more precise than an image captured by the stereo cameras 13R and 13L. Note that, the camera rotator 14 is controlled in a similar way as in the first embodiment to image the entire stereo measurement area by the telephoto camera 15.

In the alternative embodiment, as is similar to the first embodiment, positions the corresponding to a measurement point on the right and left images, which are captured by the stereo camera 13R and 13L, are obtained when the measurement point is designated by a user on a telephoto image, by means of image-matching. Note that, in the alternative embodiment, the relationship between the telephoto image and the right and left stereo images is not as accurate as the relationship in the first embodiment, so that the sizes of the low-resolution extracted image and the high-resolution extracted image are required to be larger than those in the first embodiment.

As described above, according to the alternative embodiment of the first embodiment, the effect similar to the first embodiment is obtained.

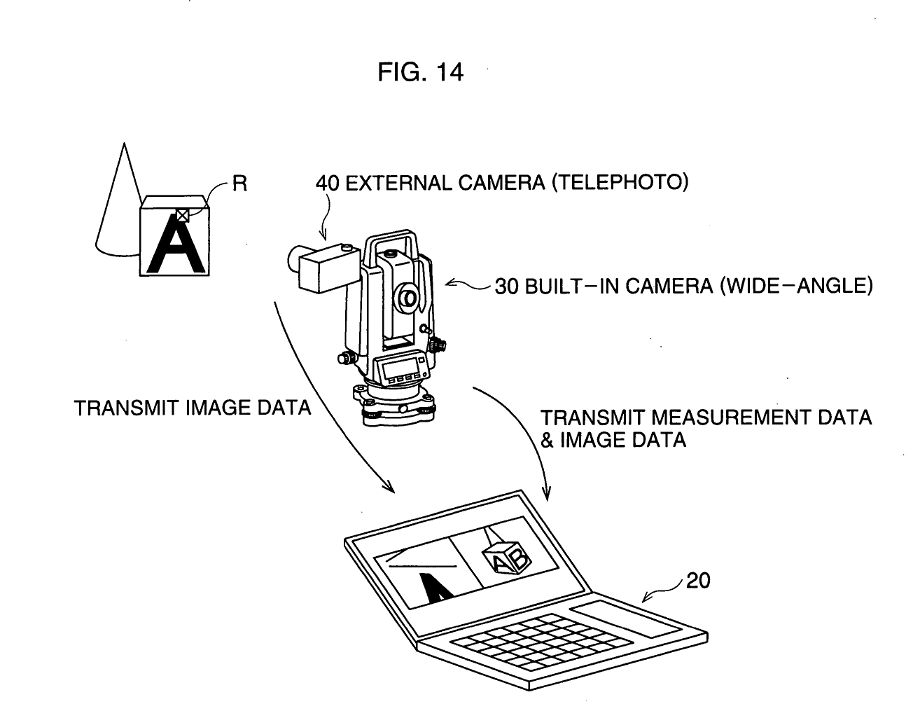

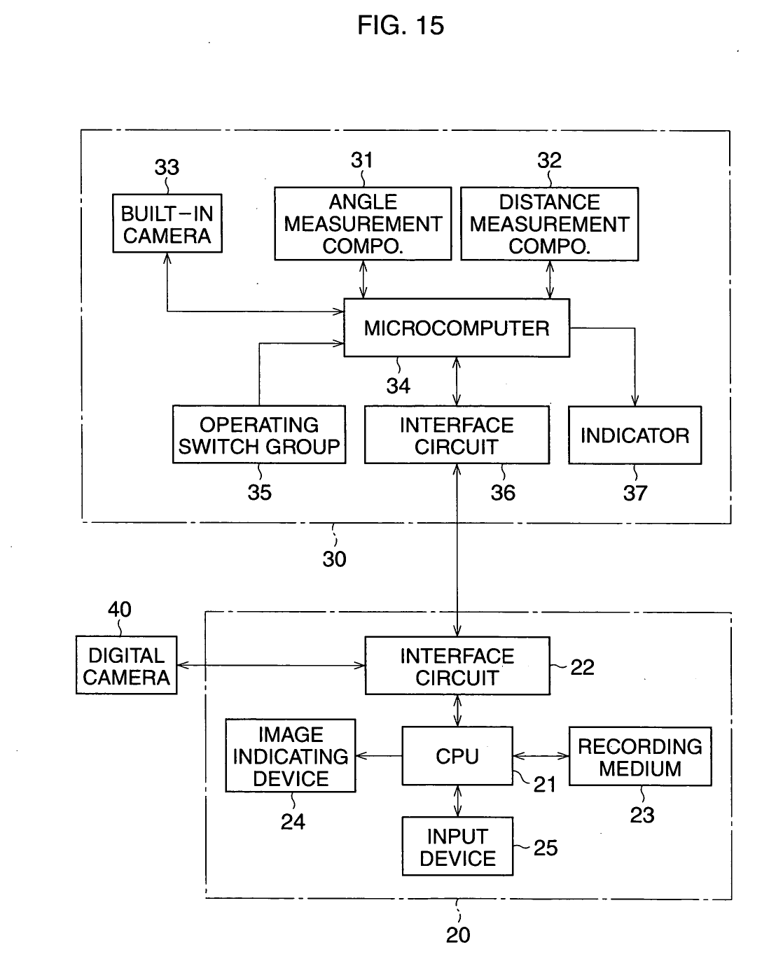

With reference to FIGS. 14 to 16, a surveying system of a second embodiment, to which the present invention is applied, will be explained. The surveying system of the second embodiment is a system that uses a surveying apparatus, such as an apparatus of a type including a total station and a theodolite. FIG. 14 schematically illustrates constructions of the surveying system of the second embodiment. Further, FIG. 15 is a block diagram showing an electrical construction of the surveying system.

As shown in FIG. 14, the surveying system generally comprises a surveying apparatus 30 (e.g. a total station), an external digital camera 40, and a computer 20 (e.g. a notebook sized personal computer). The surveying apparatus 30 is provided with a built-in digital camera. The external digital camera 40 is a camera separate from the surveying apparatus 30, so that it can be carried by a user. The surveying apparatus 30 has a sighting telescope which is rotatable about the vertical and horizontal axes. Further, the surveying apparatus 30 has an angle measurement component 31 for detecting a rotation angle about the axes and a distance measurement component 32 for detecting the distance to a point where the sighting telescope is sighted. Furthermore, the surveying apparatus 30 of the present embodiment is provided with a built-in camera 33 for capturing an image of a sighting direction.

The angle measurement component 31, the distance measurement component 32, and the built-in camera 33 are controlled by a microcomputer 34 and angle data, distance data, and image data, which are obtained for each component, are fed to the microcomputer 34. Further, an operating switch group 35, an interface circuit 36, and an indicator (e.g. LCD) 37 are also connected to the microcomputer 34. The interface circuit 36 is connected to the interface circuit 22 of the computer 20 via an interface cable and the like. Namely, the angle data, distance data, and image data, which are obtained by the surveying apparatus 30, can be transmitted to the computer 20 and stored in the recording medium 23 provided in the computer 20. Further, the external digital camera 40 is also connected to the interface circuit 22 of the computer 20, so that an image captured by the external digital camera can also be transmitted to the computer 20 as image data and stored in the recording medium 23.

In order to take a wide image about a measurement point, a relatively wide, wide-angle lens is used for the built-in camera 33 that is mounted in the surveying apparatus 30. On the other hand, the external digital camera 40 is used to take precise images about the measurement point so that a telephoto lens, which has a narrow-angle, is used for the external digital camera 40. Therefore, when an object is substantially photographed by both the built-in camera 33 and the external digital camera 40 from the same distance, the resolution of a telephoto image of the external digital camera 40 is higher than that of the wide-angle image of the built-in camera 33 of the surveying apparatus 30. Further, a precise calibration is carried out in advance for the built-in camera 33 of the surveying apparatus 30, so that the external orientation parameters of the image captured by the built-in camera 33 with respect to the surveying apparatus and the inner orientation parameters are accurately known. However, a calibration is not necessary for the external digital camera 40.

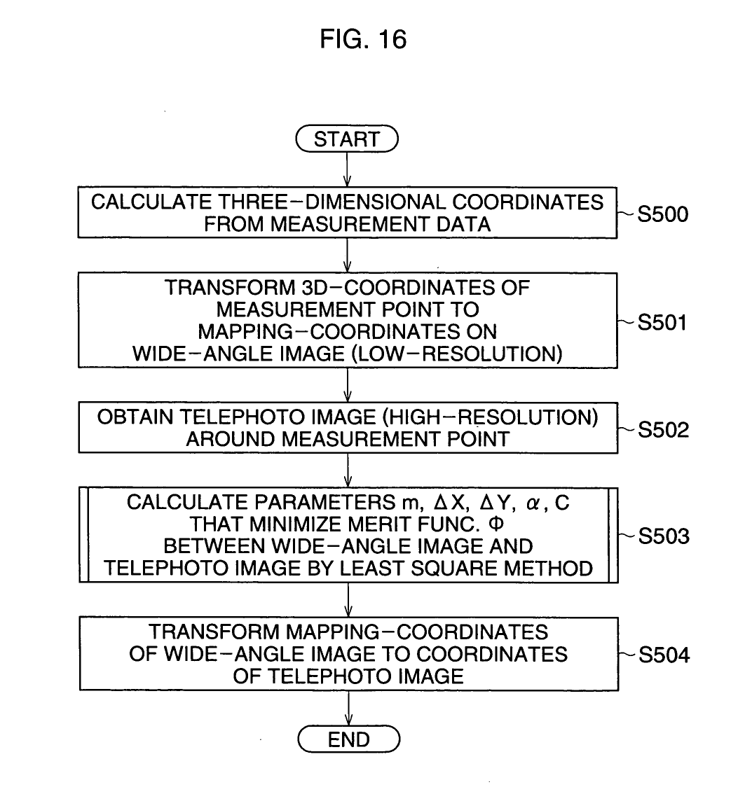

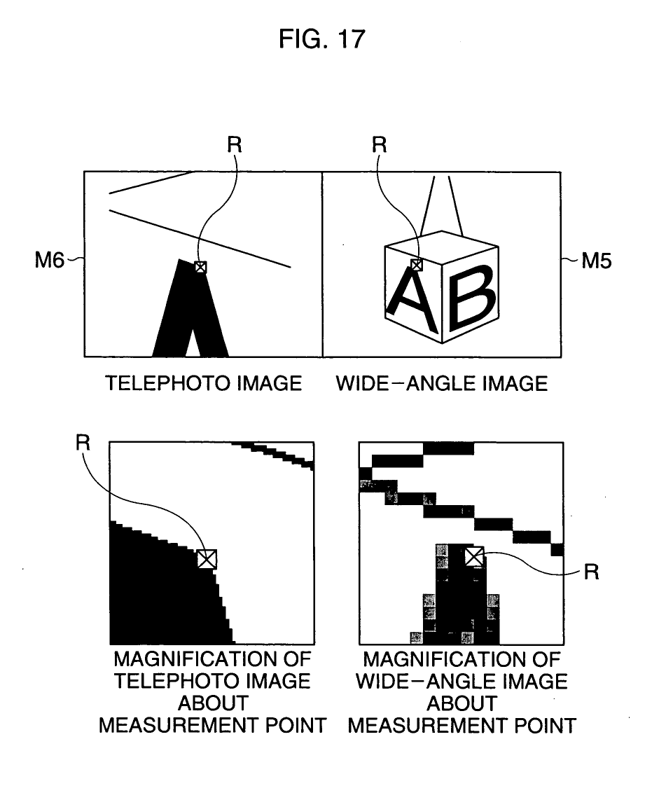

In FIG. 16, the surveying process carried out by the surveying system of the second embodiment is shown. Further, in FIG. 17, examples of the measurement point images captured by the external digital camera 40 and the built-in camera 33 of the surveying apparatus 30 are depicted. With respect to FIGS. 16 and 17, the procedures in the surveying system of the second embodiment will be explained.

In Step S500, the sighting telescope of the surveying apparatus 30 is sighted on a measurement point R (see FIG. 14) so that the distance data and the angle data for the measurement point R is obtained. Thereby, the three-dimensional coordinates of the measurement point R are calculated from these data. Further, at this time, a wide-angle image (low-resolution image) M5 of the measurement point R is simultaneously captured by the built-in camera 33, and measurement data (angle data and distance data) and image data (wide-angle image) are transmitted to the computer 20.

In Step S501, the three-dimensional coordinates of the measurement point R are transformed to the mapping coordinates (two-dimensional coordinates) on the wide-angle image M5 of the measurement point R. Namely, the three-dimensional coordinates of the measurement point R are subjected to a projective transformation using the exterior orientation parameters and the inner orientation parameters of the built-in camera 33, which are accurately given, so that they are transformed to the two-dimensional coordinates on the wide-angle image M5.

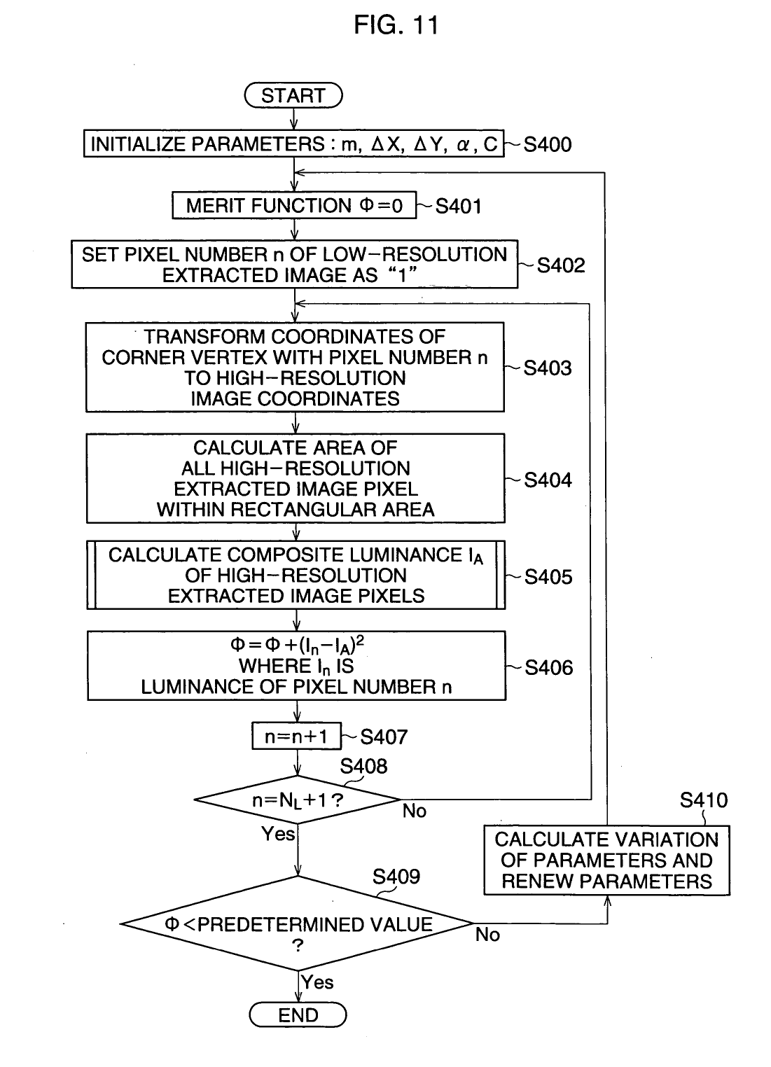

In Step S502, a telephoto image (high-resolution image) M6, which is a magnified image around the measurement point R, is photographed by the external digital camera 40 from a position close to the surveying apparatus 30, and the obtained image data are transmitted to the computer 20. In Step S503, the parameters m, ΔX, ΔY, α, and C, which minimize the value of the merit function Φ between the wide-angle image M5 and the telephoto image M6, are calculated by means of the least square method in the computer 20, in a similar way to that discussed in the first embodiment with reference to FIG. 11. Note that, in the second embodiment, the full sized telephoto image M6, for example, is used as the high-resolution extracted image.

In Step S504, the values of the parameters m, ΔX, ΔY, α, and C, which are calculated in Step S502, and the mapping coordinates of the measurement point R are substituted into Eq. (1), so that the position corresponding to the measurement point on the telephoto image M6 is calculated. Further, at this time, the positions corresponding to the measurement point are indicated on both of the wide-angle image M5 and the telephoto image M6, and further, the surveying procedure of the surveying system of the second embodiment ends. Note that, the measurement point on each of the images may be indicated by symbols, marks, characters, or the like.

As described above, according to the second embodiment, a point (e.g. measurement point) that is designated on a low-resolution wide-angle image can be accurately mapped onto a high-resolution telephoto image, so that the position of the measurement point surveyed by the surveying apparatus can be easily and precisely corresponded to the high-resolution telephoto image of an external camera which has not been calibrated. Thereby, a surveying operator can easily and swiftly indicates the accurate position of measurement points on telephoto images when he or she makes a report after the surveying.

Note that, in the second embodiment, the digital camera was provided as a built-in camera for the surveying apparatus. However, the digital camera can be provided as external to the surveying apparatus if its position with respect to the surveying apparatus is known and the calibration has been made. Further, in the second embodiment, although the built-in camera is selected as a wide-angle or low-resolution camera, and the external digital camera is selected as a telephoto or high-resolution camera, this can be the opposite, i.e. the built-in camera may be selected as a telephoto or high-resolution camera and the external digital camera may be selected as a wide-angle or low-resolution camera.

As described in the first and second embodiments, even when an object is imaged from substantially the same direction with two different resolutions, the correspondence between the relatively low-resolution image and high-resolution image can be accurately obtained, either from low to high resolution or from high to low resolution.

Note that, in the present embodiment, imaging devices which have the same number of pixels are adopted for each of the telephoto camera and the wide-angle camera, however, the number of pixels for each imaging device can be different from each other. The distinction between the high-resolution and the low-resolution is defined by relationship between the view angle and the number of pixels, i.e. ratio between the view angle and the number of pixels. Namely, the high-resolution image has a larger number of pixels per unit angle of the view angle than that of the low-resolution image.

In the present embodiment, the matching operation between the low-resolution extracted image and the high-resolution extracted image is carried out with respect to the luminance. However, when images are obtained as color images, the matching operation between the extracted images can be carried out for respective pixel values for each of the color components, such as R, G, and B images. Further, the matching operation can be performed after transforming the R, G, and B pixel values to the luminance value.

Further, in the present embodiment, each of the images is extracted so that the low-resolution extracted image is included in the high-resolution extracted image, the images can also be extracted so that the high-resolution extracted image is included in the low-resolution extracted image. However, for this to happen, the size of the high-resolution extracted image should be determined as a size that includes a plurality of pixels of the low-resolution image, while the low-resolution extracted image can be preset to the entire low-resolution image. Further, in this case, the composite luminance (or pixel value) of the high-resolution extracted image is compared to the luminance (or pixel value) of the low-resolution extracted image at an area of a pixel that partly overlaps with the high-resolution extracted image and the result is introduced to the merit function.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2003-337266 (filed on Sep. 29, 2003) which is expressly incorporated herein, by reference, in its entirety.

1. An apparatus for establishing correspondence between a first and a second image which includes the same object image, comprising:
a point designator that is used to designate a point on said first image as a designated point;
a first image extractor that extracts a predetermined area of an image surrounding the designated point as a first extracted image; and
a corresponding point searcher that searches a point on said second image, which corresponds to the designated point on said first image by image matching between said first extracted image and said second image;
wherein resolutions of said first and second images are different from each other.

2. The apparatus according to claim 1, wherein said image matching is carried out inside an overlapping area where said first extracted image and said second image overlap, based on a coincidence of pixel information between said first extracted image and said second image.

3. The apparatus according to claim 2, wherein said coincidence is calculated for each pixel unit of a low-resolution image included in said overlapping area, where said low-resolution image is one of said first image and said second image that comprises a lower resolution.

4. The apparatus according to claim 3, wherein said pixel information comprises luminance.

5. The apparatus according to claim 3, wherein said coincidence is calculated by comparing pixel information between said low-resolution image included in said overlap area and a high-resolution image included in said low-resolution image that is included in said overlap area, and the comparison is carried out for each pixel unit of said low-resolution image, further said high-resolution image is one of said first image and said second image other than said low-resolution image.

6. The apparatus according to claim 5, wherein said pixel information comprises a pixel value for each pixel.

7. The apparatus according to claim 6, wherein said pixel information for said high-resolution image included in a pixel of said low-resolution image that is included in said overlap area comprises a composite pixel value which is based on the sum of pixel values of said high-resolution image included in a pixel of said low-resolution image that is included in said overlap area.

8. The apparatus according to claim 7, wherein said composite pixel value is calculated based on an area of each pixel for said high-resolution image included in said pixel of said low-resolution image that is included in said overlap area and a compensation coefficient that compensates for a difference of pixel values between said first and second images.

9. The apparatus according to claim 8, wherein said compensation coefficient is calculated by a least square method using a merit function which is based on said coincidence.

10. The apparatus according to claim 1, wherein said corresponding point searcher obtains a point corresponding to the designated point by calculating a coordinate transformation between said first and second images.

11. The apparatus according to claim 10, wherein said coordinate transformation comprises parameters relating to translation, rotation, and magnification of one of said first image and said second image.

12. The apparatus according to claim 11, wherein optimum values of said parameters are calculated by a least square method using a merit function which is based oh said coincidence.

13. The apparatus according to claim 1, further comprising a second image extractor that extracts a predetermined area of an image surrounding said first extracted image from said second image as a second extracted image, wherein said image matching is carried out between said first and second extracted images.

14. The apparatus according to claim 1, where in said first image comprises said low-resolution image.

15. A computer program product for establishing correspondence between a first and a second image which includes the same object image, comprising:
a point designating process that designates a point on said first image as a designated point;
a first image extracting process that extracts a predetermined area of an image surrounding the designated point as a first extracted image; and
a corresponding point searching process that searches a point on said second image, which corresponds to the designated point on said first image by image matching between said first extracted image and said second image;
wherein resolutions of said first and second images are different from each other.

16. A method for establishing correspondence between a first and a second image which includes the same object image, comprising steps for:
designating a point on said first image as a designated point;
extracting a predetermined area of an image surrounding the designated point as a first extracted image; and
searching a point on said second image, which corresponds to the designated point on said first image by image matching between said first extracted image and said second image;
wherein resolutions of said first and second images are different from each other.

17. A surveying system comprising:
a stereo image capturer that captures a stereo image having a relatively wide angle of view and low resolution;
a telephoto image capturer that captures a telephoto image having a relatively narrow angle view and high resolution;
a telephoto image capturer controller that captures a plurality of telephoto images that covers an area imaged by said stereo image by rotating said telephoto image capturer;
a low-resolution image extractor that extracts a low-resolution extracted image from said stereo image, said low-resolution extracted image comprises a predetermined area surrounding a designated point which is designated on said telephoto image; and
a corresponding point searcher that searches a point on said stereo image, which corresponds to the designated point on said telephoto image by image matching between said low-resolution extracted image and said telephoto image, at sub pixel level accuracy.

18. A surveying system, comprising:
a surveying apparatus that obtains an angle and a distance of a measurement point which is sighted;
a first image capturer that images an image of the measurement point, and where a position of said first image capturer with respect to said surveying apparatus is known;
a second image capturer that images an image of the measurement point at a resolution which is different from the image captured by said first image capturer from a position separate from said surveying apparatus;
an image extractor that extracts an extracted image from the image captured by said first image capturer, and said extracted image comprises a predetermined area surrounding the measurement point; and
a corresponding point searcher that searches a point corresponding to the measurement point on the image captured by said second image capturer, by image matching between said extracted image and the image captured by said second image capturer.
